(19) United States
(12) Patent Application Publication
(10) Pub. No.: US 2004/0153550 A1
(43) Pub. Date: Aug. 5, 2004

(54) Generic method for customization of dhcp options

(76) Inventor: Joel Payeur, Quebec (CA)

Correspondence Address: Lorusso Loud & Kelly, 440 Commercial Street, Boston, MA, 02109, US

(21) Appl. No.: 10/480,140

(22) PCT Filed: Nov. 15, 2001
(86) PCT No.: PCT/CA01/01626

(30) Foreign Application Priority Data
Jun. 5, 2001 (CA) 2 348 598

(51) Int. Cl. G06F 15/16

(52) U.S. Cl. 709/228

(57) ABSTRACT

The Dynamic Host Control Protocol (DHCP) is a text-based protocol that functions over the Internet Protocol layer. The main use for this protocol is to configure rebooting networking equipment. DHCP servers can assign dynamic IP addresses to DHCP clients from a pool of addresses, or can assign static addresses manually assigned by network administrators. Along with its assigned IP address, a DHCP client is subject to receive a plethora of other useful configuration information. DHCP information, called options in DHCP lore, are typically registered with the IANA (Internet Assigned Numbers Authority), and can have virtually any format for their data field. The present invention describes a generic way of adding new options of a DHCP client by specifying the data type for the option. This allows easy customization of DHCP clients. Typical examples of this optional information are the local subnet mask and the local router's IP address.

### FIELD OF THE INVENTION

The present invention relates to Dynamic Host Control Protocol (DHCP). More specifically, the present invention is concerned with a generic method for customization of DHCP options.

### BACKGROUND OF THE INVENTION

The Dynamic Host Control Protocol (DHCP) is a well-known text-based protocol that functions over the Internet protocol layer. DHCP allows to configure networking equipment, and to assign dynamic IP addresses from a pool of addresses to DHCP clients. Alternatively, DHCP may allow network administrators to assign static addresses manually. Clients can thus identify themselves using a unique key, for example, the MAC (Media Access Control) address, which is a globally assigned number for all network-enabled hardware devices.

Along with its assigned IP address, a DHCP client is subject to receive other useful configuration information. Most of the DHCP information, called options in DHCP lore, is registered with the IANA (Internet Assigned Numbers Authority).

FIG. 1 of the appended drawings illustrates the typical DHCP message structure, as defined by the IANA. The lengths, in bytes, of the fields 12 of the static structure 10 illustrated in FIG. 1 are found in parentheses.

The standard format of DHCP options, which can be found in the “options” field 14 on FIG. 1, is illustrated in FIG. 2.

The options field 14 of the DHCP message 10 contains the various options required for the session, as stored by an IP application. Typically, the client can ask for specific options, and normally, servers are pre-configured to give out specific options as well.

The options field 14 of a DHCP message includes three subfields: a “code” subfield 16, a “len” subfield 18, and a data subfield 20.

The code subfield 16 identifies the options and is one byte long (as is indicated in parentheses). Possible “code” values therefore lie in the range [0, 255]. Such values are also known as “opcodes”.

In particular, the options identified by the values 0 and 255 are respectively “Pad” and “End” options. These two DHCP options are exceptions, as they do not have the typical structure of DHCP options. The “Pad” and “End” options facilitate encoding and decoding of DHCP options in a DHCP message. Since these two options are believed to be well known in the art, they will not be described herein in further detail.

Furthermore, as it is commonly known in the art, the options identified by opcodes ranging in [1, 127] are dedicated to IANA assignations. It is to be noted that most of these assignations are already predetermined. On the contrary, the range [128, 254] is unassigned and cannot be assigned through the IANA. Opcodes in this range are called site-specific opcodes, and are purely application specific. Any application may customize any of these opcodes. Lastly, the opcode 43 identifies the vendor-specific option.

An example of a DHCP option assigned by the IANA is the option specifying the subnet mask, identified by the opcode 1. This option is in the form of an IP address and its length is therefore set to 4 bytes.

FIGS. 3 and 4 respectively illustrate the vendor-specific (43) and site-specific ([128, 254]) options structures 22 and 24.

As can be seen by comparing FIGS. 3 and 4 to FIG. 2, the structures of the vendor-specific 22 and site-specific options 24 have generally the same format as an IANA designated DHCP option 14. However, the format of their “data” fields, respectively 26 and 28, are application-specific, i.e. it can be specified by the application requiring the DHCP client.

Indeed, since the format of data fields 26-28 are not defined by IANA, any format required by the IP application using a DHCP client may be chosen for these fields. However, as an implicit convention in the art, the vendor-specific and site-specific options are encoded in a DHCP message as a sequence of code/length/data fields, identical in syntax to the other DHCP option fields (see FIG. 2).

The site and vendor specific options 22-24 allow extending the possibility of the DHCP. However, since their format and content may vary depending on the IP application that requires them, these options require rewriting a code from one application to another in order to interpret the content of the corresponding option fields.

For example, Internet Protocol (IP) telephony products, and more specifically, network-enabled embedded devices, such as the Mediatrix 1124 from Mediatrix Telecom Inc., rely on DHCP information for configuration in accordance to the local network.

Generally, different software applications running in such devices or other similar devices requires different implementations of their DHCP option retrieval methods. This can be seen as a drawback, since each time it requires rewriting code to parse and create DHCP option fields.

### SUMMARY OF THE INVENTION

More specifically, in accordance with the present invention, there is provided a method for customization of Dynamic Host Control Protocol (DHCP) options, the method comprising:

providing a library of data types; and

defining a DHCP option as an optionrule; the optionrule including an opcode identifying the DHCP option, and at least one datarule; the at least one datarule including one of one of the data types and an optionrule.

According to a second aspect of the present invention, there is further provided a method for configuring an Internet Protocol (IP) application to use Dynamic Host Control Protocol (DHCP) options, the method comprising:

providing a library of data types;

registering a list of opcodes to be used by the IP application;

each of the opcodes identifying a DHCP option; and

registering optionrules corresponding to the opcodes; each of the optionrules including an opcode identifying the DHCP option, and at least one datarule; the at least one datarule being defined by one of one of the data types and an optionrule.

According to a third aspect of the present invention, there is also provided a method for communicating Dynamic Host Control Protocol (DHCP) messages between a DHCP server and an Internet Protocol (IP) application, the method comprising:

a) accessing a library of data types;

b) upon sending a DHCP message from the IP application to the DHCP server:

retrieving an option list including options to encode and an opcode for each of the options;

for each of the opcodes:

b)i) retrieving an optionrule corresponding to the current opcode; the optionrule including at least one datarule; the at least one datarule being defined by one of one of the data types and an optionrule;

b)ii) retrieving data corresponding to each of the options in the option list; and

b)iii) encoding, in the DHCP message to send, each of the retrieved data in a DHCP options field identified by the opcode, by interpreting the optionrule using the datarule and the library of data types; and

c) upon receiving a DHCP message to the IP application from the DHCP server:

retrieving in the received DHCP message, a list of opcodes to decode;

for each of the opcodes in the opcode list:

c)i) retrieving an optionrule corresponding to the current opcode; and

c)ii) for each optionrule, decoding in the received DHCP message data corresponding to the opcode, by interpreting the optionrule using the datarule and the library, yielding decoded DHCP data.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1, which is labelled “prior-art”, is a schematic view illustrating a DHCP message structure;

FIG. 2, which is labelled “prior-art”, is a schematic view illustrating a DHCP option structure in the DHCP message of FIG. 1;

FIG. 3, which is labelled “prior-art”, is a schematic view illustrating the vendor-specific option field in the DHCP message of FIG. 1;

FIG. 4, which is labelled “prior-art”, is a schematic view illustrating the site-specific data field structure in the DHCP message structure of FIG. 1;

FIG. 5 is a flowchart illustrating a method for customization of DHCP options, according to an embodiment of the present invention;

FIGS. 6a-6c are schematic views illustrating examples of option rules according to embodiments of the present invention;

FIG. 7 is a flowchart illustrating a method for configuring an IP application for using DHCP options, according to an embodiment of the present invention; and

FIG. 8 is a flowchart illustrating a method for communicating DHCP messages between an IP application and a DHCP server during a DHCP session, according to an embodiment of the present invention.

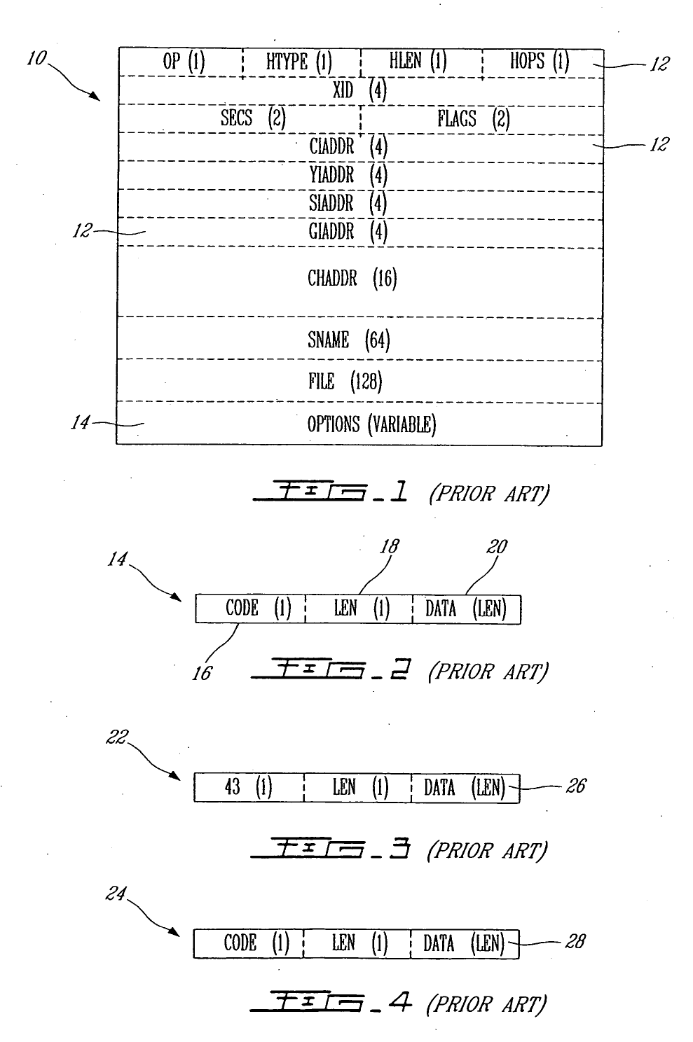

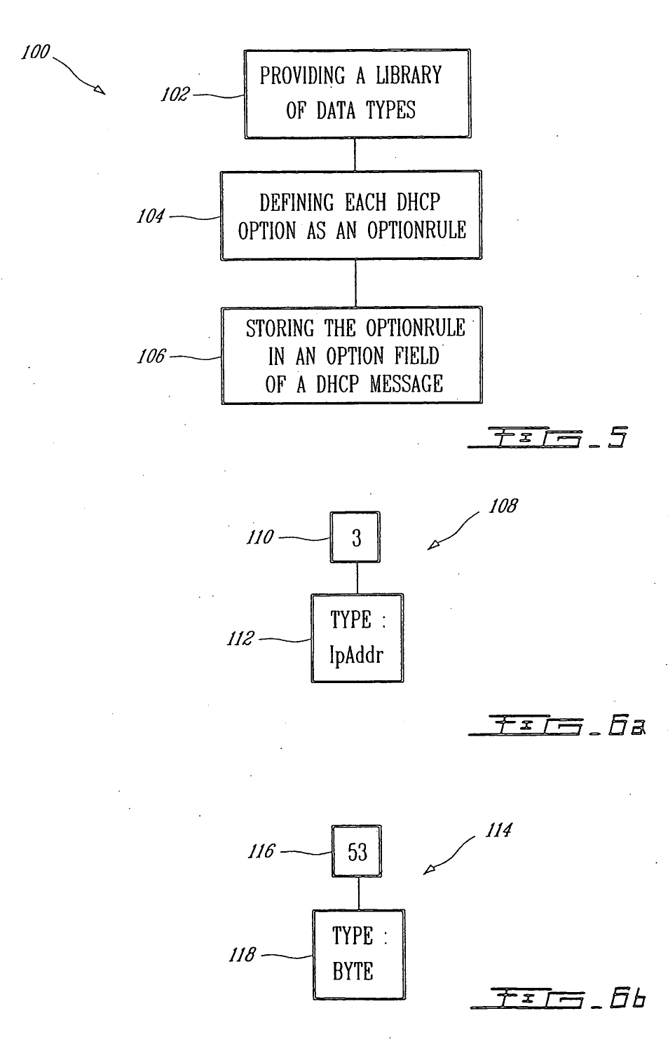

### DESCRIPTION OF THE PREFERRED EMBODIMENT

Turning now to FIG. 5 of the appended drawings, a method 100 for customization of DHCP options for an IP application, according to a first aspect of the present invention, is illustrated.

Generally stated, the method 100 consists in performing the following steps in sequence:

102—providing a library of data types;

104—defining each DHCP option as an optionrule; and

106—storing the optionrule in an option field of a DHCP message.

Each of these steps will now be described in further detail.

In step 102, a library of basic data types is provided. As will be explained in more detail hereinbelow, these data types will be used as atomic data items to characterize the data element in data subfields 20, 26 and 28 in a DHCP message (see FIGS. 2,3 and 4).

A library of data types is advantageous because some data types in the DHCP specification are redundant. Examples of such redundant data are IP addresses in numeric or doffed string form, token strings that need to be matched, integer values, etc.

The following is an example of a library of data types according to an embodiment of the present invention, in the Augmented Backus-Naur Form (ABNF):

Dhcp Option=OptionRule

OptionRule=Opcode [Length *DataRule ]

Length=(0×00−0×FF)

Opcode=(0×00−0×FF)

DataRule=(TerminalType|OptionRule)

TerminalType=(Bool|Byte|Dword|Word|MultipleBool|MultipleByte|MultipleDword|MultipleWord|VarLenIntegerString|IpAddr|DottedIpAddr|MultipleIpAddr|String|VarLenString|TokerString|ExtensionItem)

Bool=(0×00|0×01)

Byte=(0×00−0×FF)

Dword=(0×00000000−0×FFFFFFFF)

Word=(0×0000−0×FFFF)

MultipleBool=2*Bool

MultipleByte=2*Byte

MultipleDword=2*Dword

MultipleWord=2*Word

VarLenIntegerString=1*10(DIGIT)

IpAddr=(0×00000000−0×FFFFFFFF)

DottedIpAddr=3(1*3DIGIT “.”)1*3DIGIT

MultipleIpAddr=2*IpAddr

String=1*n(CHAR)

VarLenString=1*(CHAR)

TokenString=String (The token is specified and must be matched exactly)

ExtensionItem=New data type.

### EXAMPLE OF A LIBRARY OF DATA TYPES

The above example of library data types shows that even complex data items can be decomposed into a number of simpler data items.

Obviously, other data types may be defined in the library depending on the requirements of the IP application.

In the following, a data type will be said to be terminal if it can be used directly to encode/decode information in a DHCP message.

Of course, the IP application is advantageously provided with a DHCP client that is configured with instructions for translating the data types, so as to encode/decode DHCP information in the data subfield of a DHCP option.

The concepts of datarule and optionrule will now be described.

A datarule is used to indicate to an appropriately configured DHCP client a rule allowing to encode and decode an atomic item. Each datarule characterizes one or more data items in a DHCP option and includes the type of the data items (for example, a byte, an integer, a string of characters, etc.) as defined in the library.

Indeed, a great deal of diverse information may be associated with a DHCP option, especially with vendor-specific and site-specific options. A datarule is advantageously associated with each complete information required by a DHCP option. Since such complete information may include more than one element of information, a datarule may include one or more data items, globally resulting in one of the information required by a DHCP option.

In addition to the type of the data items, a datarule may also include other typical characteristics of data items in a DHCP option. Examples of these characteristics are: mandatory status (must this data item be absolutely present for the option to be valid?), the maximum/minimum/fixed length of the data field, or a predetermined value to find for this data item (for example, must equal “1” or a certain character string). For example, to represent a Datarule that must be equal to the string “Mediatrix”, we would create a datarule with the type TokenString (see the above example of library of data types) and assign “Mediatrix” to the token. When decoding, the library will then look for the specific word “Mediatrix”. Of course, other characteristics may also be used.

Other types of information may also optionally be present in a datarule to help with other tasks related to the encoding and decoding of the DHCP option. For example, a unique identificator can be included for the data item. This identificator is to be used with a separate mechanism, implemented in the IP application, for retrieving the data to encode and store the data that was parsed. That identificator would also uniquely identify a database item that would be the decoded value for the datarule, which can be used by the IP enabled application. The IP enabled application is configured to access the decoded information by knowing the identificator that was assigned to the datarule. Similarly, for encoding, the application sets the value in the database using the identificator, and the encoding entity (the code library) gets the value from the database before encoding it.

The DHCP protocol states that more than one DHCP server can answer a DHCP client's request (the DHCP client's request is typically broadcasted over the local network). In that case, the client uses an application-specific algorithm to choose which server the DHCP client will acknowledge. A typical way of doing this is to assign a value to every DHCP option that is found in the server's response, and then select the server that best suits the client's needs. This can be easily achieved by extending a datarule to contain not only an identificator that maps it to a database, but also a value for this datarule's presence in the DHCP message. For example, the assigned IP address would have a higher presence value than the subnet mask, and so if having to choose between these two messages, a DHCP client would chose the IP address. The server's proposal can be weighed by the total of its datarule's values. The assigned value will also be referred to herein as a server-choosing algorithm identificator.

An optionrule includes an opcode identifying the DHCP option, and at least one datarule specifying the format of the optionrule data field.

Optionally, an optionrule includes other information such as mandatory state and a server-choosing algorithm identificator.

In some cases, an optionrule may be considered invalid, and therefore unusable, if one of its datarules is invalid.

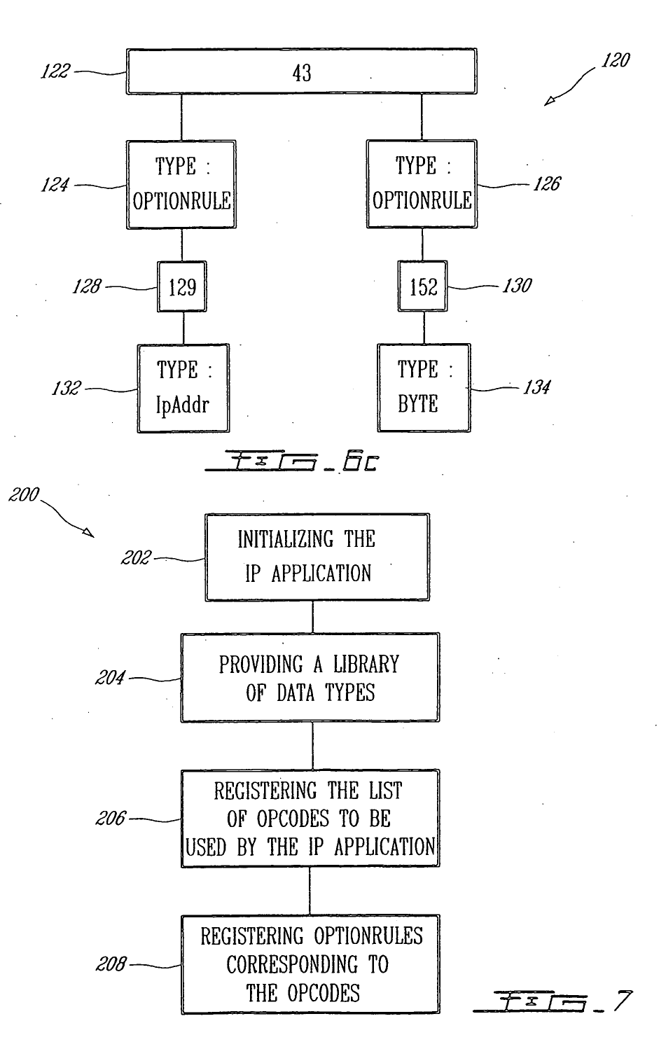

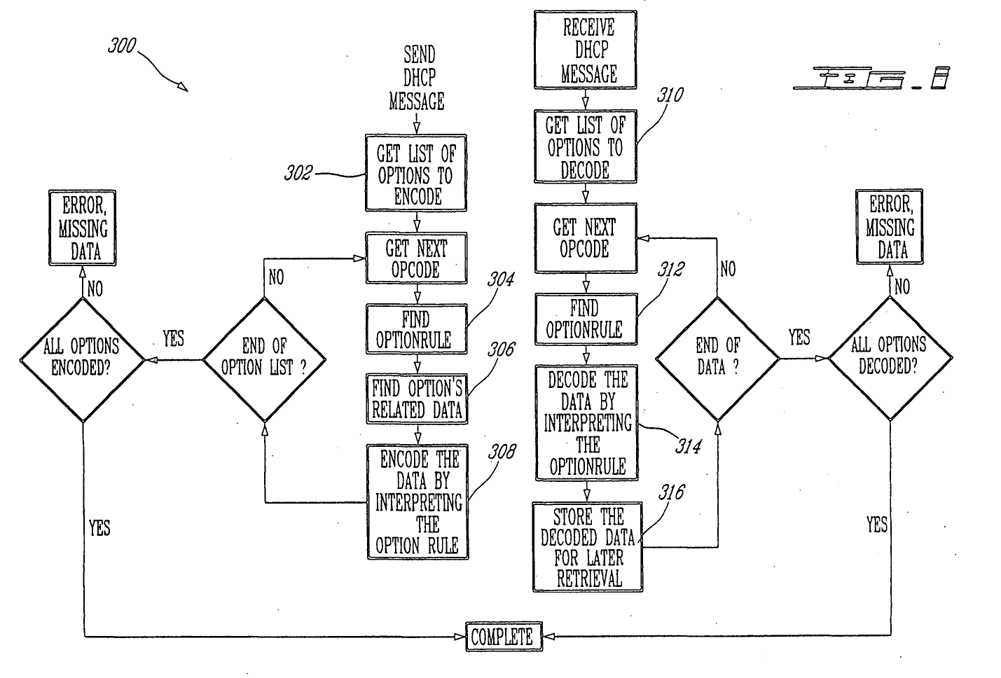

FIGS. 6a and 6b illustrate two examples of implementation of the method for customization of DHCP options according to a preferred embodiment of the present invention.

A first example is given in FIG. 6a. The optionrule 108 for the subnet option, corresponding, according to IANA, to the opcode 3, is illustrated. As can be seen in FIG. 6a, the optionrule 108 includes the opcode value 3 (reference number 110), and a single datarule 112, which specifies in this particular case that the type of data expected for the subnet option is IpAddr, as defined in the library provided in step 102. This data type corresponds to an IP address in digital format.

A second example is illustrated in FIG. 6b. In this example, the optionrule 114 for the message type, corresponding to the opcode 53, is illustrated. As can be seen in FIG. 6b, the optionrule 114 includes the opcode value 53 (reference number 116), and a single datarule 118, which specifies here that the type of data expected for the message type is byte, as defined in the library provided in step 102. Expected values for this optionrule are defined in the DHCP standard.

As can be seen from the above two examples of optionrules, optionrules and datarules may advantageously be used to encode and decode DHCP options defined and assigned by IANA, in addition to vendor and site-specific options.

Since the DHCP subnet and message type options are believed to be well known in the art, they will not be described herein in further detail.

As can be seen in the above example of library (step 102), the optionrule is advantageously defined as a data type. Considering the optionrule as an atomic item advantageously allows to create optionrules in which the data field is composed of one or more optionrules as in the vendor-specific option. Thus, the optionrule may become a basic type that can be used to specify datarules. In that case, in contrast with other basic types of datarules, optionrules that are used as a basic type of a datarule does not have an associated database identificator, since they are not used to map directly to one single data item.

A further example of an optionrule will now be presented. FIG. 6c of the appended drawings illustrates an example of an optionrule that includes a data field composed of optionrules.

The optionrule 120 includes the opcode value 43 (reference number 122), corresponding to a vendor-specific option.

The optionrule 120 further includes two datarules 124 and 126, each defining the expected data type as being optionrules. thus, this example illustrates a possible implementation of the vendor-specific option allowing to decode/encode optionrules corresponding to site-specific options corresponding to both the opcodes 129 and 152 (respectively labelled 128 and 130).

The optionrules labelled 128 includes the datarules labelled 132 defining the expected value for the corresponding option as being defined by an IP address (type IpAddr in the library), while the optionrules labelled 130 includes the datarules labelled 134 defining the expected value for the corresponding option as being defined as a byte.

It is to be noted that the datarules 124 and 126 in the optionrule 120 are not terminal since they define the expected values for this data field as being optionrules. The two datarules 132 and 134 are, however, terminal.

As illustrated in the above examples, datarules and optionrules are used for specifying the format, and optionally the container for the encoded/decoded data.

As stated hereinabove, the DHCP client that is used to encode and decode the DHCP options is configured so as to use the above-described library of data types to encode and decode optionrules according to the present invention.

The library advantageously includes sufficiently flexible data types for the datarules so that the DHCP client should not require any changes from one application to another.

Accordingly, to handle new DHCP options, appropriate datarules are created and associated to an optionrule for a particular purpose of the IP application.

Thus, the present invention allows customization of DHCP clients by providing a generic way of adding new DHCP options by pre-defining the data types for the options In accordance with this design, any user of the DHCP client is enabled to change the list of supported DHCP options, and to redefine vendor and site-specific data field formats to suit their application's needs.

The method for customization of DHCP options, according to the present invention, is advantageously based on a reusable code, therefore avoiding the writing of an unnecessary code in order to parse and/or create DHCP options. Moreover, the method provides a means to express more complex DHCP options without any changes in the core source code.

Turning now to FIG. 7, a method for configuring an IP application for using DHCP options, according to a second aspect of the present invention, is illustrated.

It will be apparent that the method 200 of FIG. 7 is implemented in a computer system (not shown) in the form of hardware or software. More specifically, the method is advantageously implemented in the context of a DHCP client (not shown).

Indeed, in addition to the IP application, the computer system advantageously includes a DHCP client in order to communicate DHCP messages to a DHCP server.

The computer system, IP application and DHCP client may all be in the form of a single IP product, for example, a network-enabled embedded device, such as an Internet phone adapter. The Mediatrix 1124 from Mediatrix Telecom Inc. is an example of such an IP product.

Since a DHCP client and a DHCP server are believed to be well known in the art, and for concision purposes, they will not be described herein in further detail.

Generally stated, the method 200 consists in performing the following steps:

202—initializing the IP application;

204—providing a library of data types;

206—registering the list of opcodes to be used by the IP application; and

208—registering optionrules corresponding to the opcodes.

Obviously, before configuring the IP application to use DHCP options, the IP product or IP application has to boot.

Each of the steps of method 200 will now be described in greater detail.

In step 202, the IP application is initialized. Step 202 advantageously includes: initialization of the IP stack (to prepare to send DHCP messages) and other non-DHCP related bootup tasks such as provisioning, etc.

As will be explained hereinbelow, the method 200 makes use of the concept of datarules and optionrules, as described hereinabove, and as is obvious, also makes use of the library of data types. Therefore, the pre-defined library of data types is provided so as to be accessed by the DHCP client. In step 204, the library is either stored in a Random Access Memory (RAM) of the system or is pre-programmed into the system.

Of course, the library of data types defines data types necessary to encode and decode the DHCP options required by the IP application and is therefore compatible with it.

Obviously, step 204 may be included in the initialization step 202.

In step 206, the list of opcodes to be used by the IP application is registered. Similarly to the library of data types, the opcode list is made available to the DHCP client. A correspondence table is advantageously provided to associate opcode values to corresponding DHCP options. Alternatively, a list of options may directly be provided.

It is to be noted that the expression “registering” will be used herein as the action of making the corresponding information available to the IP application and/or to the DHCP client.

The list of opcodes is previously stored in the system that includes the IP application, or is alternatively pre-programmed in the IP application code. The opcode may also be selected from a more thorough list using, for example, a user interface. This advantageously allows easy configuration of the IP application according to, for example, user preferences. Where the IP application is implemented in software form in a computer system, a conventional menu list may be used by the user of the IP application to select appropriate DHCP options.

In step 208, optionrules corresponding to the opcodes registered in step 206 are registered. In addition to an identifying opcode, each optionrule includes at least one datarule, as explained hereinabove.

Attention is drawn to the fact that the method 200 advantageously allows the DHCP client (and thus the IP application) to be configured to encode and decode DHCP messages.

Turning now to FIG. 8 a method 300 for communicating DHCP messages between an IP application and a DHCP server during a DHCP session, according to a further aspect of the present invention, is illustrated.

Generally stated, the method 300 consists in performing the following steps:

upon sending a DHCP message from the IP application to the DHCP server

302—providing an option list, including an opcode for each of the options in the list;

for each of the opcodes:

304—retrieving an optionrule corresponding to the opcode;

306—retrieving datarules related to the retrieved optionrule; and

308—encoding, in the DHCP message to send, each of the datarules, by interpreting the optionrule, using the library of data types; and

upon receipt of a DHCP message from the DHCP server to the IP application:

310—retrieving, in the received DHCP message, a list of opcodes to decode;

312—for each opcode in the list, retrieving an optionrule corresponding to the opcode that needs to be decoded; and

for each optionrule:

314—decoding, in the received DHCP message, data corresponding to the opcode, by interpreting the optionrule using the library; and optionally

316—storing the decoded data.

As with the configuration method 200 described hereinabove, the DHCP client (and thus the IP application) has access to the library of data types for the communication method 300.

Each of the steps of the method 300 will now be described in further detail.

As can be seen in FIG. 8, the method 300 may actually be divided into two methods: a method for encoding a message to be sent by the IP application to a DHCP server (302-308), and a method for decoding a DHCP received by the application from the DHCP server (310-316).

Although each of these two processes uses the library of data types, optionrules and datarules, they may be executed independently.

Steps 302-308 concern the encoding DHCP options upon the IP application sending a DHCP message to the. DHCP server.

In step 302, a list of options is provided for encoding. As has been discussed hereinbelow, the list of opcodes is preferably provided to the DHCP client during the configuration process 200, but it can also be provided before encoding the options.

The list of options also includes a corresponding opcode value for each option. It is to be noted that options are uniquely identified by their opcode.

Steps 304-308 are performed for each opcode.

In step 304, an optionrule corresponding to the current opcode is retrieved. As discussed hereinabove, the optionrule includes at least one datarule defined by either of the data types or an optionrule.

In step 306, the data related to the corresponding options is also retrieved.

The list of opcodes, the optionrules and the data may have been previously stored in the system that includes the IP application (or in a memory of the IP product). Alternatively, it is included in the IP application code. The opcode list may also be selected from a more thorough list using, for example, a user interface. Providing the opcodes, a table of correspondence may provide the corresponding optionrule and data.

The retrieved data is then encoded in the DHCP message to be sent by interpreting the optionrules using the library of data types (step 308).

The second method comprised in method 300 is described through steps 310-316. It concerns the decoding of DHCP options upon the IP application's receipt of a DHCP message from the DHCP.

In step 310, a list of options to decode with corresponding opcodes is retrieved in the option field of the received DHCP message. However, it is to be noted that the list of options is usually already known by the DHCP client, since the DHCP message is received in response to a previous DHCP message sent by the DHCP client to the DHCP server (see steps 302-308).

Steps 312 to 316 are performed for each of the retrieved opcodes.

The list of options is then used to associate an optionrule and an opcode corresponding to each option in the list (312).

In step 314, the data included in the option field of the received DHCP message is decoded by interpreting the optionrules associated with the current opcode, using the library of data types.

The decoded data is then preferably stored for later retrieval by the IP application. The data is advantageously stored in Random Access Memory (RAM) of the system hosting the IP application (or in the a memory of the IP product). Alternatively, any other memory means may be used, including Read Only Memory (ROM), cache, swap files, local storage means, etc.

As illustrated in FIG. 8, a test may be performed during the encoding or decoding process to assess whether all DHCP options to encode/decode have been processed.

If any error is found during the communication process 300, the IP application is advantageously configured to display an error message on a display device.

Since datarules are defined using a library of predefined data types, the length of the data in the DHCP options data fields is implicitly defined by specifying the data type.

The methods 100, 200 and 300 are advantageously implemented in C++. Alternatively, other languages may also be used without departing from the spirit and nature of the present invention.

The present invention can be used to create any kind of parsers/encoders for text-strings.

Although the present invention has been described hereinabove by way of preferred embodiments thereof, it can be modified without departing from the spirit and nature of the subject invention, as defined in the appended claims.

What is claimed is:

1. A method for customization of Dynamic Host Control Protocol (DHCP) options, the method comprising:
providing a library of data types; and
defining a DHCP option as an optionrule; the optionrule including an opcode identifying the DHCP option, and at least one datarule; the at least one datarule including one of one of the data types and an option rule.

2. A method as described in claim 1, further comprising storing the optionrule in an option field of a DHCP message.

3. A method as described in claim 1, wherein said library of data types includes terminal data types and optionrules.

4. A method as decribed in claim 1, wherein the DHCP option to customize is selected from site-specific options, vendor-specific options and IANA-assigned options.

5. A method as decribed in claim 1, wherein said optionrule includes more than one datarule.

6. A method as decribed in claim 1, wherein said at least one datarule further includes a mandatory status.

7. A method as decribed in claim 1, wherein said at least one datarule further includes information related to the length of a datafield of the DHCP option to customize.

8. A method as decribed in claim 1, wherein said at least one datarule further includes a predetermined value to be found for a corresponding data item.

9. A method as decribed in claim 1, wherein said at least one datarule further includes a unique identificator.

10. A method as decribed in claim 9, wherein said unique identificator is to be assigned by a DHCP client to a DHCP option found in a DHCP server's response, thereby allowing said DHCP client to identify and select a DHCP server according to said DHCP server's response.

11. A method as described in claim 1, wherein said optionrule further includes one of a mandatory state and a server-choosing algorithm identificator.

12. A method for configuring an Internet Protocol (IP) application to use Dynamic Host Control Protocol (DHCP) options, the method comprising:
providing a library of data types;
registering a list of opcodes to be used by the IP application; each of the opcodes identifying a DHCP option; and
registering optionrules corresponding to the opcodes; each of the optionrules including an opcode identifying the DHCP option, and at least one datarule; the at least one datarule being defined by one of one of the data types and an optionrule.

13. A method as recited in claim 12, further comprising initializing the IP application before registering the list of opcodes to be used.

14. A method as recited in claim 12, wherein said IP application includes a DHCP client.

15. A method as recited in claim 14, wherein said initializing includes initialization of a IP stack of the DHCP client.

16. A method as recited in claim 12, wherein a correspondence table is used to associate each of said opcodes values to a corresponding DHCP option.

17. A method as recited in claim 12, wherein said list of opcodes is pre-programmed in said IP application.

18. A method as recited in claim 12, wherein said list of opcodes is selected using a user interface provided by the IP application.

19. A method for communicating Dynamic Host Control Protocol (DHCP) messages between a DHCP server and an Internet Protocol (IP) application, the method comprising:
a) accessing a library of data types;
b) upon sending a DHCP message from the IP application to the DHCP server:
retrieving an option list including options to encode and an opcode for each of the options;
for each of the opcodes:
b)i) retrieving an optionrule corresponding to the current opcode; the optionrule including at least one datarule; the at least one datarule being defined by one of one of the data types and an optionrule;
b)ii) retrieving data corresponding to each of the options in the option list; and
b)iii) encoding, in the DHCP message to send, each of the retrieved data in a DHCP options field identified by the opcode, by interpreting the optionrule using the datarule and the library of data types; and
c) upon receiving a DHCP message to the IP application from the DHCP server:
retrieving in the received DHCP message, a list of opcodes to decode;
for each of the opcodes in the opcode list:
c)i) retrieving an optionrule corresponding to the current opcode; and
c)ii) for each optionrule, decoding in the received DHCP message data corresponding to the opcode, by interpreting the optionrule using the datarule and the library, yielding decoded DHCP data.

20. A method as recited in claim 19, wherein at least one of said opcode list, said optionrules and said data is stored in a computer system that includes the IP application.

21. A method as recited in claim 19, wherein said opcode list is selected using a user interface provided by the IP application.

22. A method as recited in claim 19, wherein said optionrules corresponding to opcodes are retrieved using a table of correspondence.

23. A method as recited in claim 19, wherein said decoded data is stored for later retrieval by the IP application.

24. A method as recited in claim 23, wherein said decoded data is stored in one of Random Access Memory (RAM), Read Only Memory (ROM), cache, swap files, and local storage means.
